(19) United States
(12) Patent Application Publication
(10) Pub. No.: US 2025/0229827 A1
(43) Pub. Date: Jul. 17, 2025

(54) RACK FOR A STEERING SYSTEM PROVIDED WITH AN INSERTION ZONE OF A STEERING PINION

(71) Applicant: JTEKT EUROPE, Irigny (FR)

(72) Inventors: Raphaël GAY, Fontaine Saint Martin (FR); Emeric RICHARD-VITTON, Lyon (FR)

(73) Assignee: JTEKT EUROPE, Irigny (FR)

(21) Appl. No.: 18/986,871

(22) Filed: Dec. 19, 2024

(30) Foreign Application Priority Data
Jan. 15, 2024 (FR) 24/00346

(51) Int. Cl. B62D 3/12

(52) U.S. Cl. CPC B62D 3/126

(57) ABSTRACT

A rack for a steering system including a functional zone provided with a plurality of functional teeth defining a plurality of functional recesses between two successive functional teeth, and an insertion zone extending in an extension of the functional zone, the insertion zone being provided with at least one insertion tooth defining at least one insertion recess between the at least one insertion tooth and the functional tooth positioned opposite the insertion zone, wherein a height of a gauge positioned in the insertion recess is less by an offset distance than the height of the gauge positioned in a functional recess.

### TECHNICAL FIELD

The invention concerns the field of steering systems and more particularly a rack for a steering system.

### PRIOR ART

A steering system of a vehicle has the purpose of allowing a driver to control a trajectory of the vehicle by modifying an orientation angle of the wheels of the vehicle by means of a steering wheel.

There are steering systems in which a variation in rotation of the wheels of the vehicle is carried out by a mechanical assembly composed of a steering pinion which meshes with a rack. The rack is slidably mounted in a longitudinal direction in a steering casing. The two ends of the rack, outside the casing, are respectively coupled to two steering rods, which are themselves respectively associated with the left and right steered wheels of the vehicle.

The rack comprises on the one hand a toothing formed of teeth and, on the other hand, a toothing back opposite the toothing. The toothing extends in a longitudinal direction of the rack.

Furthermore, a tooth comprises a first flank and a second flank and a vertex connecting the first flank to the second flank. Each tooth is spaced from the successive tooth by a recess.

It is known to those skilled in the art to determine characteristics of the toothing by a rating on a gauge. In other words, the characteristics of the toothing are determined relative to a gauge which is virtually positioned between two teeth, that is to say in the recesses of the toothing.

The gauge is a calibrated instrument allowing to carry out measurements. In the present case, the gauge is for example a ball having a predefined diameter.

The following characteristics of the rack are defined in the remainder of the description:
A longitudinal axis of the rack is an axis that extends along a length of the rack;
A center of the rack is the center of the virtual circle in which a section of the rack taken in a plane transverse to the longitudinal axis of the rack is at least partially inscribed;
A height of the gauge is the dimension comprised between the center of the rack and a vertex of the gauge, the gauge resting between two successive teeth of the rack.
A pitch of the toothing is the length between two centers of two gauges positioned in two successive recesses. The pitch of the rack may be fixed or variable.
A tooth bottom is the point of the recess closest to the center of the rack.
A height of the tooth bottom is the dimension comprised between the tooth bottom and the center of the rack.
A tooth height is the dimension comprised between the vertex and the center of the rack.

During an operation of the vehicle, forces are opposed to a contact between the steering pinion and the rack.

In order to permanently maintain a meshing of the rack against the steering pinion, it is known to use a so-called “push” device, acting elastically on the back of the rack in the region of the pinion to strongly press the toothing of the rack against a toothing of the pinion. Thus the push limits the clearance between the respective toothing of the steering pinion and the rack, and this push also makes it possible to control a sliding force of the rack in the steering casing.

The disadvantage posed by using a so-called a >>push>> device is that it requires an adjustment of the push after assembly of the steering pinion and the rack.

Furthermore, the <<push>> device may have failures and a large number of patent documents are known relating to improvements to this device.

Finally, such a device has a volume, a cost and a mass that manufacturers of steering systems seek to reduce.

There is therefore a need for a mechanical assembly composed of a steering pinion which meshes with a rack having a quick, easy assembly, as well as a reduced volume and mass.

### DISCLOSURE OF THE INVENTION

One embodiment concerns a rack for a steering system comprising a functional zone provided with a plurality of functional teeth defining a plurality of functional recesses between two successive functional teeth, the functional recesses being configured to cooperate with a steering pinion, the functional zone extending along a longitudinal axis of the rack, and an insertion zone extending in an extension of the functional zone, the insertion zone being provided with at least one insertion tooth defining at least one insertion recess between the at least one insertion tooth and the functional tooth positioned opposite the insertion zone, characterized in that a height of a gauge positioned in the insertion recess is less by an offset distance than the height of the gauge positioned in a functional recess.

In the remainder of the description, two elements are said to be <<identical>> if they differ from each other only by the manufacturing tolerances commonly accepted in the field.

The rack according to the invention comprises the functional zone forming a toothing of the rack and extending in a longitudinal direction of the rack.

Each tooth of the rack comprises a first flank, a second flank and a vertex connecting the first flank to the second flank. Each tooth is spaced from the successive tooth by a recess.

Characteristics of the toothing are determined with respect to a gauge which is virtually positioned between two teeth, that is to say in the recesses of the toothing.

The gauge is for example a ball having a center and predefined diameter.

The following characteristics of the rack are defined in the remainder of the description:
A longitudinal axis of the rack is an axis which extends along a length of the rack;
A center of the rack is the center of the virtual circle in which a section of the rack taken in a plane transverse to the longitudinal axis of the rack is at least partly inscribed;
A height of the gauge is the dimension between the center of the rack and a vertex of the gauge, the gauge resting between two successive teeth of the rack.
A pitch of the toothing is the length between two centers of two gauges positioned in two successive recesses. The pitch of the rack may be fixed or variable.
A profile of a tooth according to a longitudinal section of the rack comprises at least the vertex, the first flank and the second flank of the tooth, connected to the vertex.
A tooth bottom is the point of the recess closest to the rack center.
A tooth bottom height is the dimension between the tooth bottom and the center of the rack.
A tooth height is the dimension comprised between the vertex and the center of the rack.

The functional zone extends along the longitudinal axis of the rack. All the heights of the gauges positioned in the functional recesses are identical.

The insertion zone is positioned at one end of the functional zone along the longitudinal axis of the rack. The insertion zone is in contact with the functional zone.

The insertion zone allows an assembly of an innovative steering pinion-rack assembly. Indeed, according to the invention, the rack is first positioned in a steering casing such that a clearance between the rack and the steering casing is substantially the final desired clearance during operation of the assembly in a vehicle. Then the steering pinion is inserted into the steering casing at the insertion zone.

The at least one insertion tooth has a specific function, to allow the insertion of the steering pinion on the rack when the rack is positioned in the steering casing. Thus, it is obvious that the at least one insertion tooth has a determined profile upstream of its manufacture so as to guarantee that the height of the gauge positioned in the insertion recess is lower by the offset distance than the height of the gauge positioned in a functional recess.

The height of the gauge positioned in the insertion recess being lower than the height of the gauge positioned at a functional recess allows a reduction in the stresses exerted on the steering pinion-rack assembly and thus it is possible to insert the steering pinion on the rack, while the rack is already positioned in the steering casing.

According to the invention, it may no longer be necessary to push the rack against the steering pinion after insertion, for example via a <<push>> type device. Indeed, the final stressing of the steering pinion-rack assembly can be carried out when the steering pinion meshes with the teeth of the functional zone.

During the operation of the assembly in the vehicle, the steering pinion travels only through the functional zone. The insertion zone can be prohibited to the steering pinion, for example by means of a travel limiter.

The invention can therefore make it possible to carry out a final adjustment of the rack in the steering casing before the insertion of the steering pinion into said steering casing.

Unlike a toothless or flat insertion zone, the insertion zone according to the invention makes it possible, by the presence of at least one tooth, to preserve the section of the rack, taken in the plane transverse to the longitudinal axis of the rack, with little variation in the length of the rack. This allows a certain constancy of a deformation of the rack during a heat treatment operation. A toothless or flat insertion zone causes a significant variation in section and will therefore undergo significant deformations during a heat treatment, thus weakening the mechanical characteristics of the rack.

Furthermore, in the case of a steering system with a mechanical connection between a steering wheel and the steering pinion-rack assembly, the insertion zone according to the invention allows an angular indexing of the steering pinion on the rack so as to guarantee a correct alignment of the steering wheel and a midpoint of the steering pinion-rack assembly.

The subject of the present disclosure may also have one or more of the following characteristics taken alone or in combination.

According to an embodiment, a height of a tooth bottom of the at least one insertion recess is identical to the height of the tooth bottom of the plurality of functional recesses.

Thus, the insertion recesses and the functional recesses are aligned.

According to an embodiment, a height of an insertion tooth is less than the height of a functional tooth.

The insertion teeth are therefore smaller than the functional teeth.

According to an embodiment, the at least one insertion tooth has an upper profile along a longitudinal section of the rack identical to the upper profile of the functional tooth facing the insertion zone.

The upper profile of the teeth is the profile of a tooth along a longitudinal section of the rack and which comprises at least the vertex, a portion of the first flank and a portion of the second flank of the tooth, connected to the vertex.

The upper profile of the teeth is determined by a toothing calculation known to those skilled in the art.

The rack according to the invention is remarkable in that the functional tooth facing the insertion zone and the at least one insertion tooth have an identical upper profile.

Furthermore, since the height of the gauge positioned in the insertion recess is less than the height of the gauge positioned in a functional recess, the vertex of the at least one insertion tooth is offset toward the center of the rack by a distance, which is close to but not necessarily equal to the offset distance, relative to the functional tooth positioned opposite the insertion zone.

In some embodiments, the offset distance is comprised between 20% and 70%, preferably between 30% and 50%, and in particular between 35% and 45% of the height of the gauge positioned in the functional recess.

In some embodiments, the insertion zone comprises a plurality of insertion recesses, and preferably at least three insertion recesses.

Thus, the steering pinion can mesh with the at least three insertion recesses during the insertion.

In some embodiments, the insertion zone comprises an introduction part provided with at least two introduction recesses, the heights of the gauges positioned in the at least two introduction recesses being identical.

The introduction recesses are also insertion recesses.

The introduction recesses allow an easier insertion of the steering pinion.

In some embodiments, the insertion zone comprises a transition part provided with at least one transition recess, the height of the gauge positioned in the at least one transition recess is comprised between the height of the gauge positioned in the functional recess and the height of the gauge positioned in the introduction recess.

In some embodiments, the transition part is positioned between the functional zone and the introduction part.

The transition part is therefore in contact with the functional zone on the one hand and with the introduction part on the other hand.

The transition part facilitates the meshing of the steering pinion on the functional zone by gradually putting the steering pinion into an operating position, that is to say by gradually increasing the stresses exerted on the steering pinion-rack assembly.

In some embodiments, the transition part is provided with at least two transition recesses.

In some embodiments, the heights of the gauges positioned in the at least two transition recesses are linearly decreasing between the height of the gauge positioned in the functional recess and the height of the gauge positioned in the introduction recess.

Another aspect of the invention concerns a steering system comprising a rack according to the invention.

### BRIEF DESCRIPTION OF THE DRAWINGS

The invention will be better understood, thanks to the following description, which relates to several embodiments according to the present invention, given as non-limiting examples and explained with reference to the appended schematic drawings, in which:

FIG. 1 is a longitudinal sectional representation of a rack according to the invention;

FIG. 2 is an enlargement of FIG. 1;

FIGS. 3A and 3B are longitudinal sectional views of a steering pinion-rack assembly according to a first embodiment;

FIGS. 4A and 4B are longitudinal sectional views of the steering pinion-rack assembly according to a second embodiment;

FIGS. 5A and 5B are longitudinal sectional views of the steering pinion-rack assembly according to a third embodiment.

### DESCRIPTION OF THE EMBODIMENTS

Only the elements necessary for understanding the invention have been shown. To facilitate reading of the drawings, the same elements bear the same references from one figure to another.

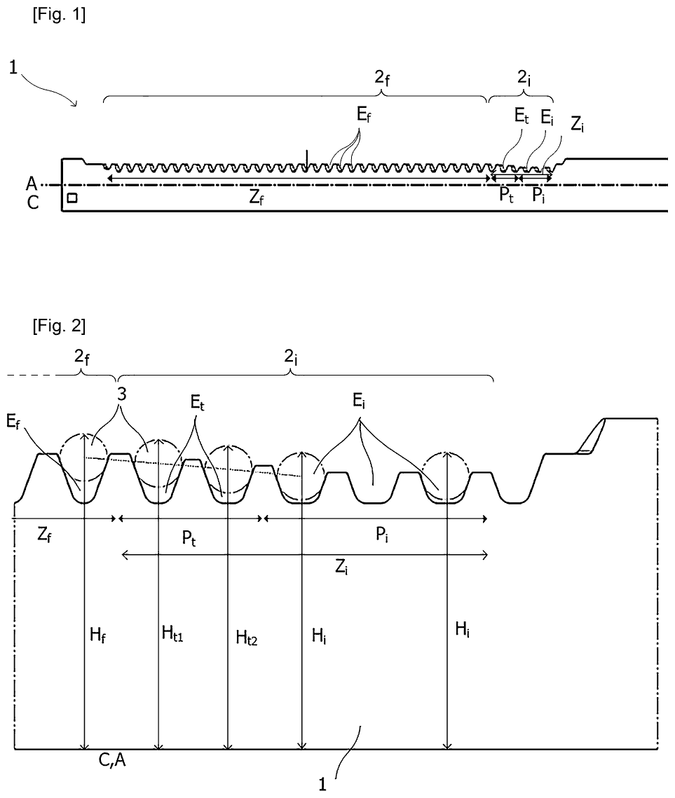

The invention relates to a rack 1, as shown in FIG. 1, for a steering system.

The rack 1 comprises a toothing formed of a plurality of teeth 2, the toothing extending along a longitudinal axis A, also called the elongation axis, of the rack 2.

Each tooth 2 comprises a vertex, a first flank and a second flank, the first flank and the second flank each being connected to the vertex at a determined angle.

A top profile of a tooth 2 according to a longitudinal section of the rack 1, as shown in FIG. 2, comprises at least the vertex, a portion of the first flank and a portion of the second flank of the tooth 2, the portion of the first flank and the portion of the second flank being connected to the vertex. The top profile of the teeth 2 is determined by a toothing calculation known to those skilled in the art.

Characteristics of the toothing are determined with respect to a gauge 3 which is virtually positioned between two teeth 2, that is to say in recesses E of the toothing as shown in FIG. 2.

The gauge 3 is for example a ball having a center and a predefined diameter.

A center C of the rack 1 is the center of the virtual circle in which is at least partly inscribed a section of the rack 1 taken in a plane transverse to the longitudinal axis A of the rack 1.

A height H of the gauge 3 is the dimension comprised between the center C of the rack 1 and a vertex of the gauge 3, the gauge 3 resting between two successive teeth 2 of the rack 1.

The toothing comprises a functional zone Z_{f}, and an insertion zone Zᵢ, said insertion zone Zᵢ comprising a transition part Pₜ and an introduction part Pᵢ.

Two successive teeth 2 are spaced apart by a recess E.

On the functional zone Z_{f}, the teeth 2 are called functional teeth 2f, and the recesses are called functional recesses E_{f}. The functional recesses E_{f} are configured to cooperate with a steering pinion 10 during normal operation of the steering system. The functional zone Z_{f} extends along the longitudinal axis A of the rack 1.

All the heights H_{f} of the gauges 3 positioned in the functional recesses E_{f} are identical.

On the insertion zone Zᵢ, the teeth 2 are called insertion teeth 2i and the recesses E are called insertion recesses Eᵢ, Eₜ.

The insertion zone Zᵢ extends in an extension of the functional zone Z_{f}. The insertion zone Zᵢ is positioned at one end of the functional zone Z_{f} along the longitudinal axis A of the rack 1. The insertion zone Zᵢ is in contact with the functional zone Z_{f}.

The insertion zone Zᵢ comprises a plurality of insertion recesses Eᵢ, Eₜ, and preferably at least three insertion recesses Eᵢ, Eₜ.

The height Hᵢ, Hₜ₁, Hₜ₂ of the gauge 3 positioned in the insertion recess Eᵢ, Eₜ is less by an offset distance than the height H_{f} of the gauge 3 positioned in the functional recess E_{f}.

More precisely, the offset distance is comprised between 20% and 70%, preferably between 30% and 50% and in particular between 35% and 45% of the height H_{f} of the gauge 3 positioned in the functional recess E_{f}.

According to an embodiment, a height of a tooth bottom of the at least one insertion recess Eᵢ, Eₜ is identical to the height of the tooth bottom of the plurality of functional recesses E_{f}.

Thus, the insertion recesses Eᵢ, Eₜ and the functional recesses E_{f} are aligned.

According to an embodiment, a height of an insertion tooth 2i is less than the height of a functional tooth 2f.

The insertion teeth 2i are therefore smaller than the functional teeth 2f.

According to an embodiment, the at least one insertion tooth 2i has an upper profile according to a longitudinal section of the rack 1 identical to the upper profile of the functional tooth 2f opposite the insertion zone Zᵢ.

The upper profile of the teeth 2 is the profile of a tooth 2 according to a longitudinal section of the rack 1 and which comprises at least the vertex, a portion of the first flank and a portion of the second flank of the tooth, connected to the vertex.

According to an embodiment, the rack 1 according to the invention is remarkable in that the functional tooth 2f facing the insertion zone Zᵢ and the at least one insertion tooth 2i have an identical upper profile. Furthermore, since the height Hᵢ, Hₜ₁, Hₜ₂ of the gauge 3 positioned in the insertion recess Eᵢ, Eₜ is less than the height H_{f} of the gauge 3 positioned in the functional recess E_{f}, the vertex of the at least one insertion tooth 2i is offset in the direction of the center C of the rack 1 by a distance, which is close to but not necessarily equal to the offset distance, relative to the functional tooth 2f positioned facing the insertion zone Zᵢ.

On the transition part Pₜ, the recesses E are called transition recesses Eₜ, while on the introduction part Pᵢ, the recesses are called introduction recesses Eᵢ.

The introduction recesses Eᵢ and the transition recesses Eₜ are also insertion recesses Eᵢ, Eₜ.

The introduction part Pᵢ is provided with at least two introduction recesses Eᵢ, the heights Hᵢ of the gauges positioned in the at least two introduction recesses Eᵢ being identical.

The introduction recesses Eᵢ allow an easier insertion of the steering pinion 10.

The height Hₜ₁, Hₜ₂ of the gauge 3 positioned in the at least one transition recess Eₜ is comprised between the height H_{f} of the gauge 3 positioned in the functional recess E_{f} and the height Hᵢ of the gauge 3 positioned in the introduction recess Eᵢ.

The transition part Pₜ is positioned between the functional zone Z_{f} and the introduction part Pᵢ.

The transition part Pₜ is therefore in contact on the one hand with the functional zone Z_{f} and on the other hand with the introduction part Pᵢ.

The transition part Pₜ facilitates the meshing of the steering pinion 10 on the functional zone Z_{f} by gradually putting the steering pinion 10 in an operating position, that is to say by gradually increasing the stresses exerted on the steering pinion 10—rack 1 assembly.

The transition part Pₜ is provided with at least two transition recesses Eₜ.

The heights Hₜ₁, Hₜ₂ of the gauges 3 positioned in the at least two transition recesses Eₜ are linearly decreasing between the height H_{f} of the gauge 3 positioned in the functional recess E_{f} and the height Hi of the gauge 3 positioned in the introduction recess Eᵢ.

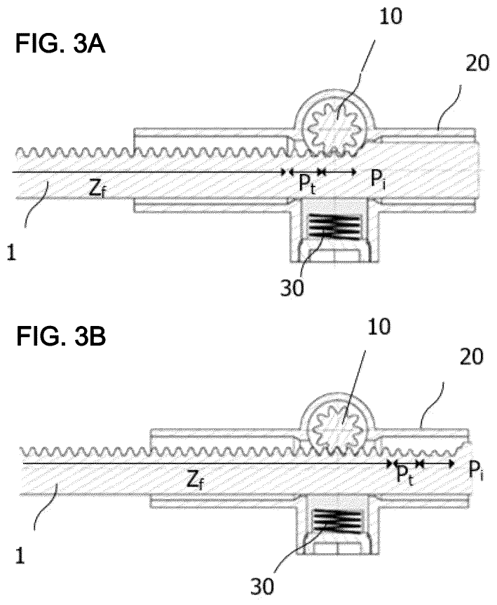

FIGS. 3A, 3B, 4A, 4B and 5A and 5B illustrate embodiments of an assembly of the steering pinion 10 on the rack 1 in different steering casings 20, 20′, 20″. More particularly, FIGS. 3A, 4A and 5A illustrate the position of the steering pinion 10 relative to the rack 1 when it is inserted into the steering casing 20, 20′, 20″. FIGS. 3B, 4B, and 5B illustrate the position of the steering pinion 10 relative to the rack 1 during normal operation of the steering system.

When assembling the steering pinion 10—rack 1 assembly according to the invention, the rack is first positioned in the steering casing 20, 20′, 20″.

According to the first embodiment, FIGS. 3A and 3B, the steering casing 20 comprises a <<push>> device 30 previously adjusted so that the «push>device exerts a force towards the rack equal to the force that must be exerted in normal operation.

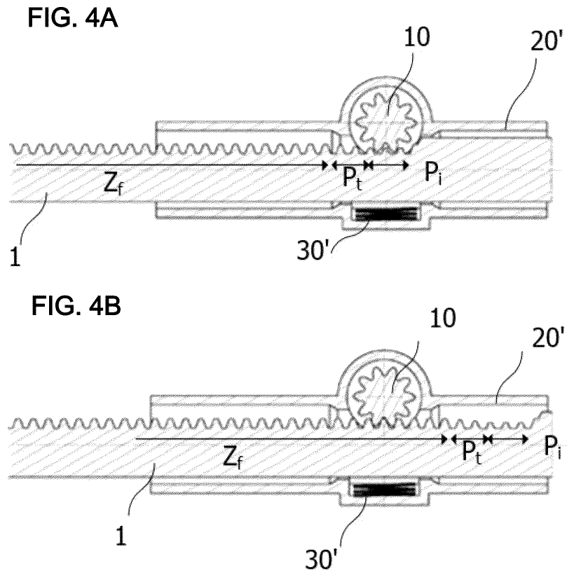

According to the second embodiment, FIGS. 4A and 4B, the steering casing 20′ comprises a spring 30′ exerting a predetermined force towards the rack 1. Said spring 30′ cannot be adjusted.

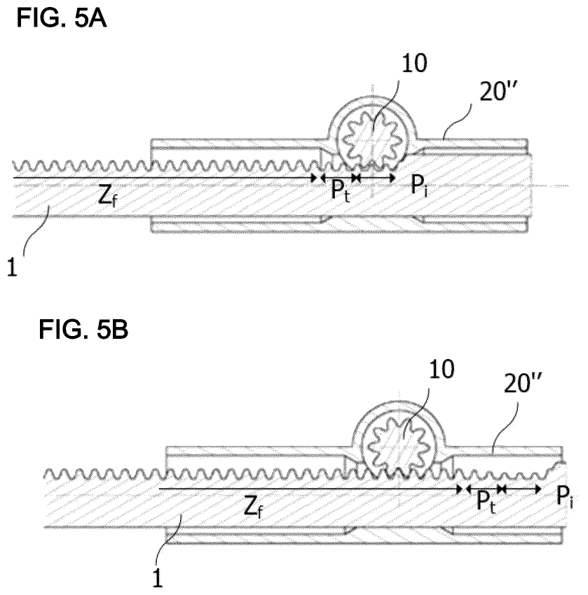

According to the third embodiment, FIGS. 5A and 5B, the steering casing 20″ does not comprise any specific device exerting a thrust towards the rack 1.

In each of the embodiments, the rack 1 is slidably mounted in the steering casing 20, 20′, 20″.

In each of the embodiments, the insertion zone Zᵢ allows an assembly of the innovative steering pinion 10—rack 1 assembly. Indeed, according to the invention, the rack 1 is first positioned in the steering casing 20, 20′, 20″ as illustrated in FIGS. 3a, 4a, 5a such that a clearance between the rack 1 and the steering casing 20, 20′, 20″ is substantially the final desired clearance during operation of the assembly in a vehicle.

Then the steering pinion 10 is inserted into the steering casing 20, 20′, 20″ at the insertion zone Zᵢ, as illustrated in FIGS. 3A, 4A and 5A, and more precisely at the introduction part Pᵢ. Indeed, the height Hᵢ of the gauge 3 positioned in an introduction recess Eᵢ lower than the height H_{f} of the gauge 3 positioned in a functional recess E_{f} allows a reduction in the stresses exerted on the rack 1 and thus it is possible to insert the steering pinion 10 into the steering casing 20, 20′, 20″.

Then the steering pinion 10 is moved in rotation along the rack 1 so as to travel through the transition part Pₜ. The transition part Pₜ gradually places the steering pinion 10—rack 1 assembly under stress. Finally, the steering pinion 10 is positioned on the functional zone Z_{f}, as illustrated in FIGS. 3B, 4B, 5B. The insertion zone Zᵢ is then prohibited to the steering pinion 10, for example by means of a travel limiter.

According to the invention, it is no longer necessary to push the rack 1 against the steering pinion 10 via, for example, a <<push>> type device 30 adjusted after the positioning of the steering pinion 10. Indeed, the final stressing is carried out when the steering pinion 10 meshes with the teeth 2f of the functional zone Z_{f}. During operation of the assembly in the vehicle, the steering pinion 10 only travels through the functional zone Z_{f}. The invention can therefore make it possible to adjust the rack 1 in the steering casing 20, 20′, 20″ before inserting the steering pinion 10.

Although the present invention has been described with reference to specific embodiments, it is obvious that modifications and changes can be made to these examples without departing from the general scope of the invention as defined by the claims. In particular, individual features of the various illustrated/mentioned embodiments may be combined in additional embodiments. Therefore, the description and drawings should be considered in an illustrative rather than restrictive sense.

It is also obvious that all features described with reference to a method are transposable, alone or in combination, to a device, and conversely, all features described with reference to a device are transposable, alone or in combination, to a method.

1. A rack for a steering system comprising:
a functional zone provided with a plurality of functional teeth defining a plurality of functional recesses between two successive functional teeth of the plurality of functional teeth, the plurality of functional recesses being configured to cooperate with a steering pinion, the functional zone extending along a longitudinal axis of the rack, and
an insertion zone extending from the functional zone, the insertion zone being provided with at least one insertion tooth defining at least one insertion recess between the at least one insertion tooth and a functional tooth of the plurality of functional teeth positioned opposite the insertion zone,
wherein a height of a gauge positioned in the at least one insertion recess is less by an offset distance than a height of the gauge positioned in a functional recess of the plurality of functional recesses.

2. The rack according to claim 1, wherein the at least one insertion tooth has an upper profile according to a longitudinal section of the rack identical to the upper profile of the functional tooth positioned opposite the insertion zone.

3. The rack according to claim 1, wherein the offset distance is between 20% and 70% of the height of the gauge positioned in the functional recess of the plurality of functional recesses.

4. The rack according to claim 1, wherein the insertion zone comprises a plurality of insertion recesses.

5. The rack according to claim 4, wherein the insertion zone comprises an introduction part provided with at least two introduction recesses, a heights of the gauges being positioned in the at least two introduction recesses being identical.

6. The rack according to claim 5, wherein the insertion zone comprises a transition part provided with at least one transition recess, and
a height of the gauge positioned in the at least one transition recess is between the height of the gauge positioned in the functional recess and the height of the gauge positioned in one of the at least two introduction recesses.

7. The rack according to claim 6, wherein the transition part is positioned between the functional zone and the introduction part.

8. The rack according to claim 6, wherein the transition part is provided with at least two transition recesses.

9. The rack according to claim 8, wherein heights of the gauges positioned in the at least two transition recesses are linearly decreasing between the height of the gauge positioned in the functional recess of the plurality of functional recesses and the height of the gauge positioned in one of the at least two introduction recesses.

10. A steering system comprising the rack according to claim 1.
